(19) United States
(12) Patent Application Publication
(10) Pub. No.: US 2019/0086303 A1
(43) Pub. Date: Mar. 21, 2019

(54) SLIDE RACK DEVICE FOR SLIDE SPECIMEN PROCESSING

(71) Applicant: XIAMEN TALENT BIOMEDICAL TECHNOLOGY COMPANY, LTD., Fujian (CN)

(72) Inventors: James GUO, Guangdong (CN); Derek GUO, Guangdong (CN)

(73) Assignee: XIAMEN TALENT BIOMEDICAL TECHNOLOGY COMPANY, LTD., Fujian (CN)

(21) Appl. No.: 16/087,107

(22) PCT Filed: Mar. 21, 2017
(86) PCT No.: PCT/CN2017/077568

§ 371 Date: Sep. 21, 2018

(30) Foreign Application Priority Data
Mar. 21, 2016 (CN) 201610160797.0
Aug. 31, 2016 (CN) 201610798094.0

(51) Int. Cl. G01N 1/36; G01N 1/31

(52) U.S. Cl. CPC G01N 1/36; B01L 3/5027; B01L 2300/0822; G01N 1/31

(57) ABSTRACT

A slide rack device for slide specimen processing mainly includes a cover plate, a slide, a slide rack, and a spring piece. The slide rack is provided with a plurality of integrated V-shape insertion slots and a spring piece fixedly disposed inside the V-shape insertion slot. The insertion slot is V-shape and provided upright or inclined, and a plurality of slide assemblies which are assembled by a slide specimen to be tested and the slide cover plate can be closely placed in the insertion slot, so that space utilization is greatly enhanced. It is easy and convenient to assemble or disassemble the slide assembly from the insertion slot. The slide rack can endure higher temperature. When a heat treatment is required in the specimen processing, the slide is inserted in the rack, and then a bottom of the slide is immersed in a hot medium for heating.

### TECHNICAL FIELD

The present invention belongs to a field of biological specimen processing, and specifically relates to a slide rack device for biological slide specimen processing.

### BACKGROUND

The whole process of testing of proteins, pathogens or genes on a slide specimen, such as by immunohistochemistry and by in-situ hybridization gene testing, requires dozens of complicated steps, and accuracy of the test result thereof may be severely affected by various factors such as environment and manual operation. Simplifying an operation process and reducing an influence of environment are of the highest priority to enhance an efficiency and accuracy of specimen testing.

Currently, during the testing process, a slide specimen is laid horizontally which takes large space and limits the number and efficiency of the slide specimen processing.

A reagent is dispensed from the above of the slide, which makes a big position error. After the reagent is added, open incubation may easily lead to a problem of evaporation of the reagent and drying of the specimen.

Usually, the reagent is added by dispensing from above of the slide. Before dispensing, liquids that previously present on the slide need to be removed and the slide is required to be drained off and wiped. Such operations bring a high degree of manual error, and an amount of the residual liquid may affect a concentration and an efficacy of the reagent in next step. The process of wiping the slide may also damage the specimen and may lead to the drying of specimen that is wiped previously and thereby resulting in a failure of the specimen processing.

During the specimen processing, a majority of specimens require a heat treatment. A majority of specimens require a heat treatment during processing, which is a necessary step to make a characteristic protein of an antigen or a pathogen restore to an original shape, or to make gene strands melt. The heating is generally performed at a temperature of 80 to 121° C. and maintained for 3 to 60 minutes. The most common methods are cooking in an autoclave, conventional boiling, cooking in a microwave oven, or heating in water bath. However, at present, container or shelf that is used for slide specimen processing in the manual operation is neither heat-resisting, nor has a heating function. During the slide specimen processing, the slide specimen needs to be transferred into a container that can be heated, and then transferred back to an operation desk in normal-temperature, thereby increasing complexity of the operation process and the operation error.

The present invention achieves that in the process of the slide specimen processing, the slide assembly assembled by the slide cover plate and the slide is inserted on a slide rack and remains still. There's no need to take or transfer the slide manually during the whole process of the slide specimen processing, thereby simplifying the operation steps of the slide specimen processing and enhancing the efficiency and quality of the slide specimen processing.

### SUMMARY OF THE INVENTION

In order to solve the aforesaid problems, the present invention provides a slide rack device for slide specimen processing. A slide assembly is cooperatively formed by a cover plate and a slide. The slide assembly is inserted upright or inclined in an insertion slot on the slide rack, so that the slide assembly may be placed closely, and that space is greatly saved to facilitate a requirement of processing a large amount of specimens. There's one tiny gap at the middle of the slide assembly. A reagent fills the gap via the effects of gravity and capillary siphoning, and evenly covers the specimen on the slide. Regardless of a position of the specimen, the specimen may be covered by the reagent. The slide rack device for slide specimen processing of the present invention is made of a high-temperature resisting material. The slide assembly which is inserted on the slide rack may be immersed directly or with the bottom partially inserted in a heating medium for heating. Even if evaporation generates during heating, solution in a capillary gap may also be immediately replenished by sucking liquid from a gap opening at the bottom of the assembly without drying of the specimen. In the whole process of the processing, the relative position between the slide cover plate and the slide is held still from the beginning to the end without separation. There's no need to take or transfer the slide manually during the whole process of the slide specimen processing, and the slide is always remained in the same device.

Objectives of the present invention are achieved at least by one of the following technical solutions.

A slide rack device for slide specimen processing, comprises a cover plate, a slide, a slide rack and a spring piece. The slide rack is provided with a plurality of integrated V-shape insertion slots which are upright or inclined. A spring piece is fixedly disposed inside each of the V-shape insertion slot. The spring piece is made of a material which is identical to that of the rack, or is made of a sheet metal.

An outline of an upper end of a slide assembly assembled by the slide and the cover plate matches the V-shape insertion slot on the rack, so that the slide assembly can be inserted in the V-shape insertion slot on the slide rack, so as to form a plurality of slide assemblies are arranged closely.

The spring piece and the V-shape insertion slot of the slide rack are connected in integrity, or are independently and separately disposed. When independent separation is adopted, a spring piece plate is fixed inside the V-shape insertion slot by engagement or adhesion. When the slide assembly is inserted in the V-shape insertion slot, a surface of the cover plate presses the spring piece, and the spring piece plays a function of tightly clamping the slide and the slide cover plate.

Further preferably, the slide rack is made of a heat-resisting material for enduring a heat treatment process during testing of a slide specimen.

Further preferably, a plurality of V-shape insertion slots are closely arranged in a column. The slide rack comprises single-column or multi-column of the V-shape insertion slots. A slide rack having single-column insertion slots or multi-column insertion slots is formed.

Further preferably, multi-column of the V-shape insertion slots are placed in parallel to form an insertion slot rack with several rows and several columns for slides.

Further preferably, the slide cover plate comprises a capillary plane, a depth locating surface, a width locating block, a bottom locating block, a reservoir side surface and a reservoir opening surface.

Two depth locating surfaces are provided above two lateral sides facing toward each other of the capillary plane. The capillary plane is parallel to the depth locating surfaces. Portions of a surface of the slide which are close to edges of two sides are attached to the depth locating surfaces, so that a capillary gap is formed between a slide surface and the capillary plane. One or more than one width locating blocks are provided at an outer edge of each depth locating surface which is far away from the capillary plane. A vertical distance between the width locating blocks located on different depth locating surfaces matches a width of the slide to play a stopping function. The bottom locating block is provided at a bottom of the depth locating surface.

The reservoir opening surface is connected with an upper end of the capillary plane and forms an angle A1, and A1 is a plane angle of 1 degree to 175 degree. Two sides of the reservoir opening surface are respectively connected with one reservoir side surface. The reservoir opening surface, two reservoir side surfaces, and a slide plane together constitute one reagent loading reservoir which communicates with the capillary gap. A bottom of the capillary gap has a gap opening. A length of the slide cover plate corresponds to or is equal to that of the slide. One label dent is provided on each side of the reservoir side surface which is attached to the slide surface, that is, upper ends of the two depth locating surfaces are each provided with the label dent. When a label is stuck to the slide, the label dent provides enough space for containing a thickness of the label, so as to enable the slide cover plate to be tightly pressed against the slide without being affected by whether the label is stuck to the slide.

Further preferably, outer sides of the two reservoir side surfaces are provided with top stripes for enhancing a friction between the reservoir side surface and a finger.

Further preferably, a vertical distance between the capillary plane and the depth locating surface is 0.01 to 0.5 mm, so that after the slide cover plate is pressed tight against the slide, one capillary gap having a spacing of 0.01 to 0.5 mm is formed between the slide surface and the capillary plane. A thickness of the width locating block that is higher beyond the depth locating surface is 0.1 to 1 mm.

Further preferably, the bottom locating block is upward hook-like. The bottom locating block and the width locating block together determine a relative position after the cover plate is pressed against the slide, and keeping the cover plate being pressed tight against the slide.

Further, a bottom of the capillary plane is further provided with two guiding corners. One funnel-type guiding opening is formed between the two guiding corners, and allows solution in the capillary plane to flow out of the guiding opening. A height of the guiding corners relative to the capillary surface is aligned to the depth locating surface.

Further preferably, the slide rack may be closely placed in parallel to form a slide rack device having multi-row and multi-column insertion slots, in which the slide assemblies in single-row or multi-row and in single-column or multi-column may be inserted.

Further preferably, the slide rack device is made of a material which withstands a temperature of 80° C. or above, such as polycarbonate.

Compared to the prior art, the present invention has following advantages and technical effects:

The slide rack device of the present invention has a simpler structure and lower cost, so that a plurality of slide assemblies can be more closely inserted. A slide assembly that can be inserted with several rows and several columns is formed with a tight structure, thus less space is taken and a large amount of slide specimens can be processed. Columns can be configured independently of each other or in integrity, and an arrangement configuration in single-row or multi-row and in single-column or multi-column is formed and inserted with a large amount of slide specimens to be tested. The slide is placed inclined or upright to save the space. It is simple and convenient to assemble or disassemble the slide and the cover plate from the slot. The insertion slot device has a heat resistance. When the slide specimen requires a heat treatment, there's no need to remove the slide. The slide can remain in the insertion slot on the slide rack for the heat treatment. There's no need to take or transfer the slide manually during the whole process of the slide specimen processing.

### BRIEF DESCRIPTION OF THE DRAWINGS

FIG. 1 shows a diagram of a slide rack device in an embodiment.

FIG. 2 shows a diagram of a slide rack device providing with a plurality of insertion slots in an embodiment.

FIG. 3 shows a diagram of a slide rack inserted with slide assemblies in an embodiment.

FIG. 4 shows a structural diagram of a slide cover plate in an embodiment.

FIG. 5 shows a diagram of a slide assembly which is assembled by the slide cover plate and the slide in an embodiment.

FIG. 6a shows a front projection of FIG. 5.

FIG. 6b shows a side view of FIG. 5.

FIG. 6c shows a partial enlarged view of FIG. 5.

### DETAILED DESCRIPTION OF THE PREFERRED EMBODIMENT

The present invention is further described below in combination with specific embodiments, but implementations and protection of the present invention are not limited by these.

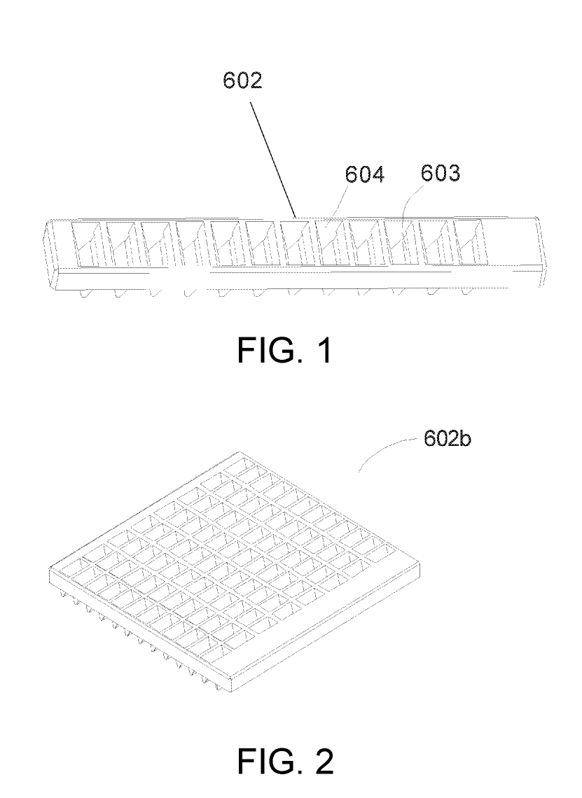

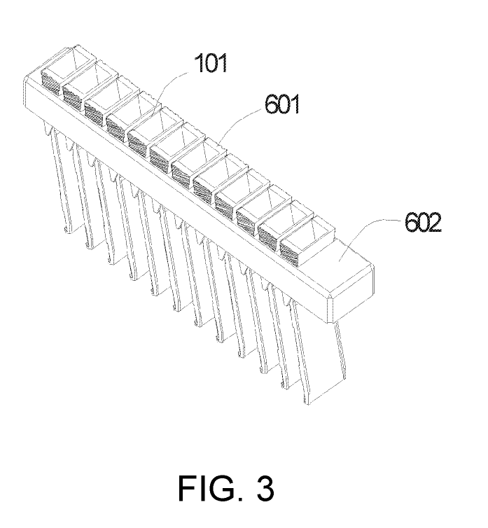

As shown in FIGS. 1 to 3, a slide rack device for slide specimen processing, mainly comprises a cover plate 601, a slide 101, a slide rack 602, and a spring piece 603. The slide rack 602 is provided with a plurality of integrated V-shape insertion slots 604 which are configured upright or inclined. A spring piece 603 is fixed inside the V-shape insertion slot and is made of a material which is identical to that of the rack, or is made of a sheet metal. The slide rack 602 is made of a heat-resisting material (such as polycarbonate).

An outline of an upper end of a slide assembly assembled by the slide 101 and the cover plate 601 matches the V-shape insertion slot 604 on the rack, so that the slide assembly can be inserted in the V-shape insertion slot 603 on the slide rack 602, so as to form a plurality of slide assemblies are arranged closely. The V-shape insertion slot is provided upright or inclined with an angle of 1° to 90°. The V-shape insertion slots are arranged in single-row or multi-row and in single-column or multi-column. The arrangement number of rows and number of columns can be provided according to the requirement of an amount of specimens that are prepared to be tested. The slide assembly which is assembled by the slide and the slide cover plate can be inserted inclined or upright in the V-shape insertion slot with an angle of 1° to 90°.

A plurality of V-shape insertion slots are arranged closely in a column. The slide rack 602 comprises single-column or multi-column of the V-shape insertion slots. A slide slot rack 602 having single-column insertion slots or a slide slot rack 602b having multi-column insertion slots is formed, as shown in FIG. 2.

As an embodiment, the spring piece 603 in the insertion slot can be made of plastic, sheet copper, sheet spring steel, or other elastic materials. The assembly made by the slide 101 fitting with the cover plate 601 is inserted along the V-shape insertion slot of the rack. A surface (back) of the cover plate 601 presses the spring piece 603, and a spring pressure is generated to applied on the slide 101 and the cover plate 601 to clamping the both.

As another embodiment, the slide cover plate can be shorter than the slide. Space for sticking a label or identifying a label is provided at an upper end of the slide 101.

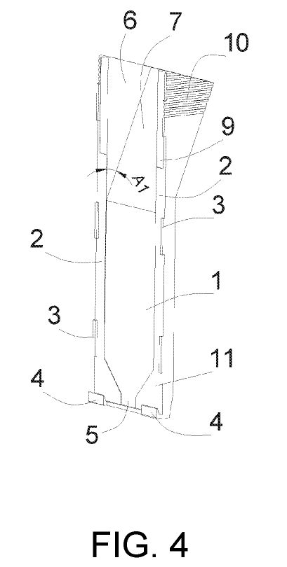

As an optimized embodiment which is more suitable for the design of the present invention, a length of the slide cover plate corresponds to that of the slide, but a label dent 9 is provided on the slide cover plate. When the label is stuck to the slide, a fit attachment between the slide cover plate and the slide 101 is still not affected. As shown in FIG. 4, the cover plate can be further optimized and improved. For example, as a preferable embodiment, a bottom locating block 4 of the cover plate is optimized as a locating hook (hook like), which provides a locating function and assists a plate-type spring to clamp the cover plate and the slide, thereby guaranteeing an accuracy of a capillary gap.

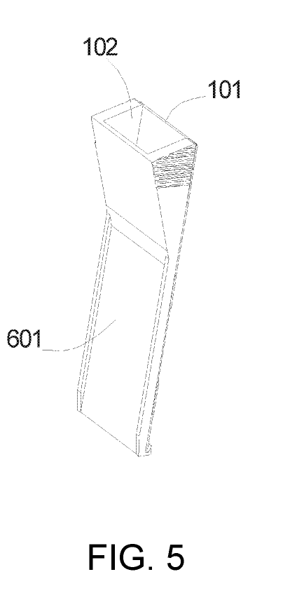

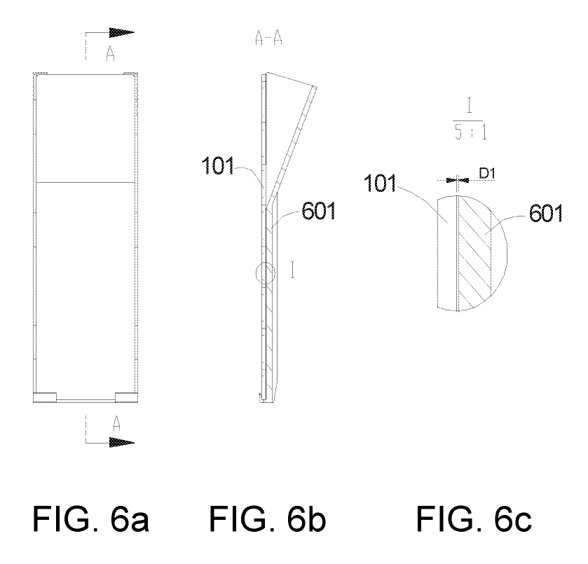

As shown in FIGS. 4, 5, and 6a to 6b, the slide cover plate comprises a capillary plane 1, a depth locating surface 2, a width locating block 3, a bottom locating block 4, a reservoir side surface 6, and a reservoir opening surface 7. Two depth locating surfaces 2 are provided above two lateral sides facing toward each other of the capillary plane 1. The capillary plane 1 is parallel to the depth locating surfaces. Portions of a plane of the slide which are close to edges of two sides are attached to the depth locating surfaces 2, so that a capillary gap is formed between a slide surface and the capillary plane 1. One or more than one width locating blocks 3 are provided at an outer edge of each depth locating surface 2 which is far away from the capillary plane 1. A vertical distance between the width locating blocks 3 located on different depth locating surfaces 2 matches a width of the slide to play a stopping function. The bottom locating block 4 is provided at a bottom of the depth locating surface 2. The reservoir opening surface 7 is connected with an upper end of the capillary plane 1 and forms an angle A1, and A1 is a plane angle of 1 degree to 175 degree. Two sides of the reservoir opening surface 7 are respectively connected with one reservoir side surface 6. The reservoir opening surface 7 and two reservoir side surfaces 6 and a slide plane together constitute one reagent loading reservoir which communicates with the capillary gap. A bottom of the capillary plane 1 is further provided with two guiding corners 11. One funnel-type guiding opening 5 is formed between the two guiding corners, and allows solution in the capillary plane to flow out of the guiding opening.

As further optimized implemented, a length of the slide cover plate corresponds to or is equal to that of the slide. One label dent 9 is provided on each side of the reservoir side surface 6 which is attached to the slide plane, that is, upper ends of the two depth locating surfaces 2 are each provided with one label dent 9. When the label is stuck to the slide, the label dent provides enough space for containing a thickness of the label, thereby enabling the slide cover plate to be tightly stuck with the slide without being affected by whether the label is stuck to the slide. Outer sides of the two reservoir side surfaces 6 are provided with top stripes 10 for enhancing a friction between the reservoir side surface 6 and the finger.

A vertical distance between the capillary plane 1 and the depth locating surface 2 is 0.01 to 0.5 mm, so that after the slide cover plate is tightly pressed against the slide. One capillary gap having a spacing of 0.01 to 0.5 mm is formed between the slide surface and the capillary plane 1. A thickness of the width locating block 3 that is higher beyond the depth locating surface 2 is 0.1 to 1 mm. The bottom locating block 4 is upward hook-like. The bottom locating block 4 and the width locating block 3 together determine a relative position after the cover plate is pressed against the slide, and keeping the cover plate being pressed tight against the slide. A bottom of the capillary plane 1 is further provided with two guiding corners 11. One funnel-type guiding opening 5 is formed between the two guiding corners, and allows solution in the capillary plane to flow out of the guiding opening. A height of the guiding corners 11 relative to the capillary plane is aligned to the depth locating surface 2.

The V-shape insertion slot structurally fits with the slide assembly, and the rack device has a simpler structure. When in use, it only requires the fingers to clamp the top stripes portions of two reservoir side faces and the slide, so that it is easy to insert the slide assembly into the insertion slot. Uneven stressing generating when a top end of the slide is pressed and separation of the slide from the slide cover plate owing to deviation of a stressing direction are prevented, guaranteeing the formation and accuracy of the capillary gap and making the operation simpler and faster. Besides, arrangement of the slide assemblies can be tighter, which further saves space and enhances a processing efficiency.

Embodiment: the slide cover plate has a dimension as follows. A length of the depth locating surface 2 is 75 mm. A distance between inner sides of two width locating blocks 3 is 28 mm, D1=0.2 mm, D2=0.5 mm. The capillary plane has a length of 50 mm and a width of 20 mm. The label dent has a depth of 0.2 mm and a length of 25 mm. An inclined angle (A1) between the reservoir opening surface and the depth locating surface is 30°. The slide has a length of 75 mm, a width of 25 mm and a thickness of 1 mm. A biological specimen on the slide has a thickness of 0.01 mm. The V-shape insertion slot is inclined by 75°. The slide rack device is made of a material which withstands a temperature of 80° C. or above, such as polycarbonate. It is indicated from the experiment that the insertion slot can be closely inserted with a plurality of slide assemblies containing specimen that is to be tested. Fitting between the slide and the cover plate was tight and accurate. It is simple and convenient to assemble or disassemble the slide and the cover plate from the V-shape insertion slot. The slide assembly which was inserted in the V-shape insertion slot of the slide rack device can be heated in a container filled with liquid, and liquid in the capillary gap is prevented from bubble accumulation or drying. A good staining effect was achieved in an immunohistochemical specimen staining test.

According to the disclosure and teaching of the above description, those skilled in the art of the present invention may further modify and alter the above implementations. Therefore, the present invention is not limited by the above disclosure and the described specific implementations, and some alteration and modification of the present invention shall also fall into the scope of protection as claimed by the claims of the present invention.

1. A slide rack device for slide specimen processing, the slide rack device comprising a cover plate, a slide, a slide rack, and a spring piece, the slide rack is provided with a plurality of integrated V-shape insertion slots which are upright or inclined, the spring piece is fixedly disposed inside each of the V-shape insertion slot, and the spring piece is made of a material which is identical to that of the slide rack, or is made of a sheet metal;
wherein, an outline of an upper end of a slide assembly assembled by the slide and the cover plate matches the V-shape insertion slot on the rack, so that the slide assembly is insertable in the V-shape insertion slot on the slide rack, so as to faun a plurality of slide assemblies that are closely arranged;
wherein, the spring piece and the V-shape insertion slot of the slide rack are configured as an integrated connection structure, or are independently and separately disposed, when the spring piece and the V-shape insertion slot are independently and separately disposed, the spring piece is fixed inside the V-shape insertion slot by engagement or adhesion, when the slide assembly is inserted in the V-shape insertion slot, a surface of the cover plate presses the spring piece, and the spring piece plays a function of tightly clamping the slide and the slide cover plate.

2. The slide rack device for slide specimen processing according to claim 1, wherein the slide rack is made of a heat-resisting material for enduring a heat treatment process during a slide specimen testing.

3. The slide rack device for slide specimen processing according to claim 1, wherein a plurality of V-shape insertion slots are closely arranged in a column, and the slide rack device comprises single-column or multi-column of the V-shape insertion slots.

4. The slide rack device for slide specimen processing according to claim 3, wherein multi-column of the V-shape insertion slots are closely placed in parallel to form an insertion slot rack with several rows and several columns for slides.

5. The slide rack device for slide specimen processing according to claim 1, wherein the slide cover plate comprises a capillary plane, a depth locating surface, a width locating block, a bottom locating block, a reservoir side surface and a reservoir opening surface;
wherein, two depth locating surfaces are provided above two lateral sides facing toward each other of the capillary plane, the capillary plane is parallel to the depth locating surfaces, portions of a plane of the slide which are close to edges of two sides thereof are attached to the depth locating surfaces, so that a capillary gap is formed between a slide surface and the capillary plane, one or more than one width locating blocks are provided at an outer edge of each of the depth locating surfaces which is far away from the capillary plane; a vertical distance between the width locating blocks located on different depth locating surfaces matches a width of the slide to play a stopping function, and the bottom locating block is provided at a bottom of the depth locating surface;
wherein, the reservoir opening surface is connected with an upper end of the capillary plane and forms an angle, and the angle is a plane angle of 1 degree to 175 degree, two sides of the reservoir opening surface are respectively connected with one reservoir side surface, the reservoir opening surface, two reservoir side surfaces, and the slide plane together constitute one reagent loading reservoir which communicates with the capillary gap, and a bottom of the capillary gap has a gap opening.

6. The slide rack device for slide specimen processing according to claim 5, wherein a length of the slide cover plate corresponds to or is equal to that of the slide, one label dent is provided on each side of the reservoir side surface which is attached to the slide plane, that is, upper ends of the two depth locating surfaces are each provided with the label dent, and when the label is stuck to the slide, the label dent provides enough space for containing a thickness of the label, so as to enable the slide cover plate to be tightly pressed against the slide without being affected by whether the label is stuck to the slide.

7. The slide rack device for slide specimen processing according to claim 5, wherein outer sides of the two reservoir side surfaces are provided with top stripes for enhancing a friction between the reservoir side surfaces and the finger.

8. The slide rack device for slide specimen processing according to claim 5, wherein a vertical distance between the capillary plane and the depth locating surface is 0.01 millimeter to 0.5 millimeters, so that after the slide cover plate is tightly pressed against the slide, one capillary gap having a spacing of 0.01 millimeter to 0.5 millimeters is formed between the slide surface and the capillary plane; and a thickness of the width locating block that is higher beyond the depth locating surface is 0.1 millimeter to 1 millimeter.

9. The slide rack device for slide specimen processing according to claim 5, wherein the bottom locating block is upward hook-like, the bottom locating block and the width locating block together determine a relative position after the cover plate is pressed against the slide, and keeping the cover plate being pressed tight against the slide.

10. The slide rack device for slide specimen processing according to claim 5, wherein a bottom of the capillary plane is further provided with two guiding comers; one funnel-type guiding opening is formed between the two guiding corners, and allows solution in the capillary plane to flow out of the guiding opening, and a height of the guiding corners relative to the capillary plane is aligned to the depth locating surface.
